(19) United States
(12) Patent Application Publication
(10) Pub. No.: US 2007/0018416 A1
(43) Pub. Date: Jan. 25, 2007

(54) Three- or four-wheeled, pedal-powered vehicle

(76) Inventor: Hugues Escarguel, Arzens (FR)

Correspondence Address: YOUNG & THOMPSON, 745 SOUTH 23RD STREET, 2ND FLOOR, ARLINGTON, VA, 22202, US

(21) Appl. No.: 10/582,510

(22) PCT Filed: Oct. 20, 2003
(86) PCT No.: PCT/FR03/03092

§ 371 Date: Jun. 9, 2006

(30) Foreign Application Priority Data
Dec. 10, 2002 (FR) 02/15594

(51) Int. Cl. B62D 61/06

(52) U.S. Cl. 280/62

(57) ABSTRACT

The invention relates to a three- or four-wheeled, pedal-powered vehicle. According to the invention, the chassis (3) of the vehicle comprises a central beam (10) and at least one horizontal frame (11, 12) which is fixed to the front of the beam (10). Moreover, the aforementioned beam (10) comprises different elements of the vehicle, in particular the steering column (45) and a cranktset (27) support (18) which is disposed level with, or slightly in front of or behind, the axle for the two front wheels (2) and which is mounted such that each pedal is located on one side of the beam (10). Said beam (10) is also connected to the rear wheel(s) (2). The frame(s) (11, 12) are dimensioned such that the user's feet and part of his/her legs are positioned inside the frame(s) during pedaling, said frame(s) forming on either side two stacked horizontal side members, to which one of the front wheels(s) (2) of the vehicle is mounted.

The present invention relates to a three- or four-wheeled pedal-powered vehicle.

Many models of three or four wheeled pedal-powered vehicles have been contemplated. Documents DE-A-29 22 691, U.S. Pat. No. 4,993,733, FR 910 287 and U.S. Pat. No. 4,674,762 illustrate some of these models.

However, the existing vehicles are not perfectly satisfactory.

Some actually have very long wheel bases, imposed by the desire of positioning the pedal crankset behind the axle of the front wheel(s) and of positioning the seat of the driver in front of the axle of the rear wheel(s). This wheel base leads to a vehicle which is not very easy to handle and whose bulkiness is a penalty.

Other vehicles on the contrary have very short wheel bases, made possible by the positioning of the crankset in front of the axle of the front wheel(s). However these vehicles have the significant drawback of not providing very good safety to the user or to third parties, taking into account the prominence of the crankset on the front of the vehicle and the exposure of the legs of the user in case of accident. Further, these vehicles do not provide very good stability in close curves.

Certain existing vehicles impose to the user a hardly comfortable more or less stretched out driving position.

Further, existing vehicles have chassis structures which are not perfectly satisfactory in terms of weight/stiffness ratio, involving relatively complex manufacturing, and which do not allow easy assembly of the different members of the vehicle.

The existing vehicles further are either lacking in any suspension, which does not make them very pleasant to use, or provided with not very performing suspensions.

The invention aims at finding a remedy to all these drawbacks.

Moreover, potential purchasers of this type of vehicle may desire to either purchase a tricycle vehicle or a quadricycle vehicle, and existing vehicles are either of one type or of the other, without any possibility of easy adaptation. It may therefore be of interest to have a vehicle which may easily be transformed from a tricycle into a quadricycle, or vice versa, from the same basic components.

The object of the invention is also to meet this requirement.

The main object of the invention is therefore to provide a vehicle with an average wheel base, providing good protection of the legs of the user and having good performances in handle ability and stability in the curves.

Another object of the invention is to provide a vehicle with a chassis structure with a good weight/stiffness ratio, of relatively simple manufacturing and allowing easy assembly of the different members of the vehicle.

A further object of the invention is to provide a vehicle in which the user has a comfortable driving position.

Still another object of the invention is to provide a vehicle with performing suspensions.

The object of the invention is also to provide a vehicle which may be rapidly and easily transformed from a tricycle to a quadricycle and vice versa.

In order to achieve at least the main object mentioned above, the chassis of the vehicle according to the invention comprises a central beam and at least one horizontal frame, fixed to the front side of the beam; the beam includes different members of the vehicle, in particular the steering column and a crankset support located level with the axle of both front wheels, or slightly in front of or behind this axle, and mounted in such a way that each pedal is located on one side of the beam, said beam being further connected to the rear wheel(s); the frame(s) are dimensioned such that the user's feet and part of his/her legs are located inside these frame(s) during pedaling, the frame(s) forming, on each side, two stacked horizontal side members, onto which one of the front wheel(s) of the vehicle is mounted.

The central beam allows the different members (steering, crankset support, rear wheel(s)) of the vehicle to be rigidly assembled, without interfering with pedaling, taking into account the position of the pedals on either side of the beam.

This beam also allows the crankset to be mounted level with the axis of both front wheels, or slightly in front of or behind this axle.

With the positioning of the crankset, together with the presence of the frame(s) it is possible to perfectly protect the legs of the user in case of accident, so that the vehicle according to the invention is perfectly safe for the user.

The frame(s) further allow the front wheels of this vehicle to be mounted resistantly, by means of two stacked side members which they form on each side of the vehicle.

Preferably, the vehicle comprises a seat mounted on the beam, conformed in order to receive the user in a substantially sitting position, slightly tilted rearwards.

This seat receives the user in a comfortable driving position in front of the rear wheel(s). The wheel base of the vehicle thus remains limited, with a very favorable mass distribution.

Advantageously, each side of a frame comprises a suspension triangle pivotably mounted relatively to it around a longitudinal axis, both triangles located on a same side being connected to a part including the wheel, and a damper being placed between this part and one of the side members of the frame(s).

The vehicle according to the invention thus comprises a particularly performing front suspension.

Preferably, the rear wheels are mounted on an arm pivotably connected at the rear end of the beam so that this arm may swing in a vertical plane, a damper being placed between this swinging arm and the beam.

The vehicle thus also comprises a performing rear suspension.

Advantageously, in this case, the vehicle comprises a primary transmission formed by a chain extending between at least one chainwheel of the crankset, and at least one pinion coaxial with the pivot axis of the swinging arm, and a secondary transmission formed by a chain extending between at least one pinion rotationally integral with the pinion(s) of the primary transmission, and at least one pinion rotationally integral with the rear wheel(s).

The rear arm may thereby swing without affecting the transmission.

Preferably, the beam or the swinging rear arm, comprises a transverse bore which may receive either a short shaft supporting a single rear wheel, or a long shaft which may receive two wheels.

It is thus possible to produce either a tricycle vehicle or a quadricycle vehicle simply by placing either said short shaft or said long shaft on the beam or the rear arm.

The vehicle may comprise at least one disc brake, in particular a disc brake on each front wheel.

The vehicle may comprise a tilted steering column, and advantageously means for adjusting the length and/or the tilt of this steering column.

The invention will be better understood, and other features and advantages thereof will become apparent with reference to the appended schematic drawing, which illustrates, as a non-limiting example, a preferred embodiment of the relevant vehicle.

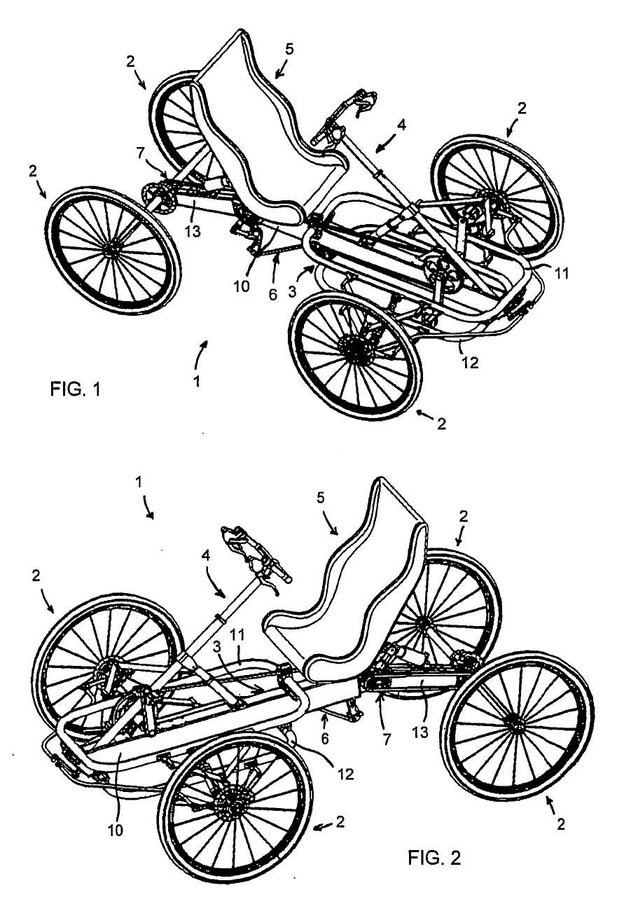

FIGS. 1 and 2 are perspective views thereof, under two different angles;

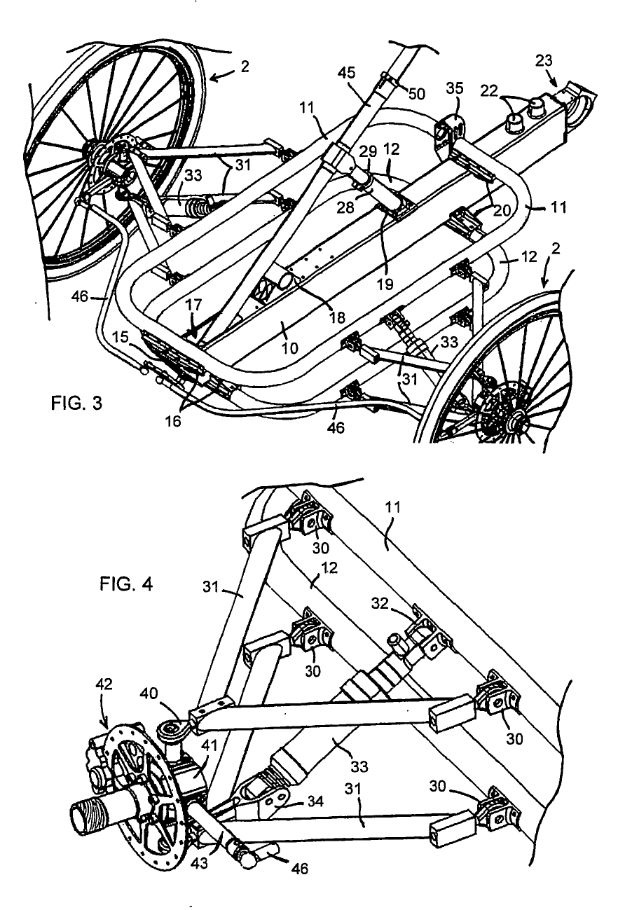

FIG. 3 is a perspective view, at an enlarged scale, of the front portion of its chassis, of its front wheels and of its steering system;

FIG. 4 is a detailed perspective view of one of the front suspensions;

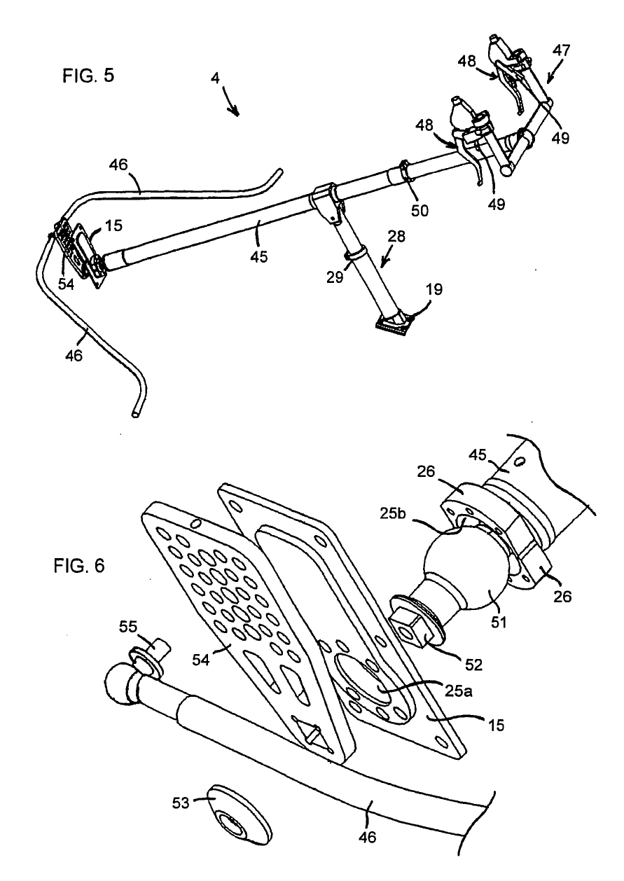

FIG. 5 is a perspective view of its steering system;

FIG. 6 is an enlarged, exploded view of a portion of this system;

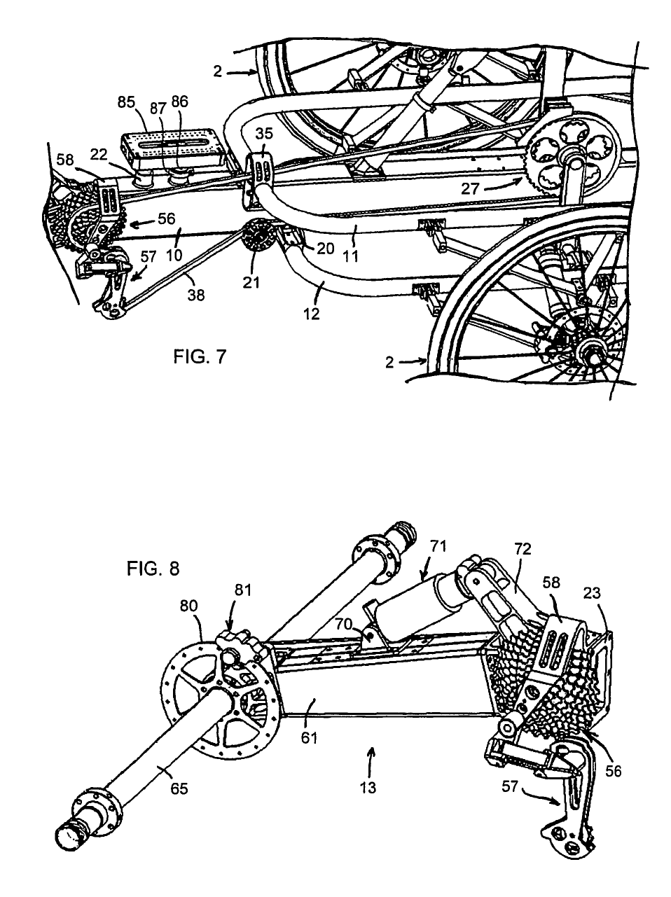

FIG. 7 is a perspective view at an enlarged scale, of a primary transmission which it comprises;

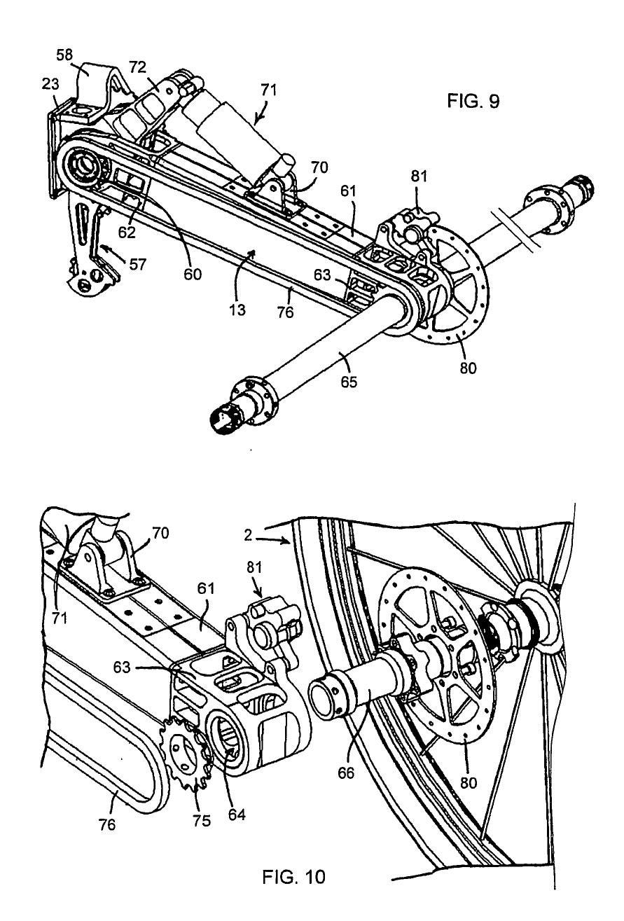

FIGS. 8 and 9 are perspective views under two different angles and at an enlarged scale, of the rear portion of its chassis;

FIG. 10 is a perspective view of the rear wheel assembly in the case of a tricycle vehicle, and

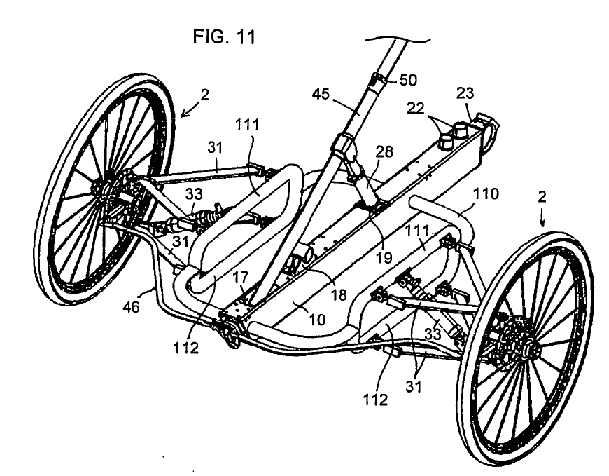

FIG. 11 is a perspective view, at an enlarged scale, of the front portion of its chassis, of its front wheels and of its steering system, according an alternative embodiment.

The figures illustrate a pedal-powered vehicle 1 with four wheels 2, and comprising a chassis 3, a steering 4, a seat 5, a primary transmission 6, and a secondary transmission 7.

The wheels 2 in the illustrated example are with spokes and tires; they may however be of any other type.

The chassis 3 comprises a central beam 10, two stacked horizontal frames 11, 12, and a rear swinging arm 13.

The beam 10 is formed with a box of rectangular section and delimits upper, lower, and side faces.

As shown in FIGS. 3 and 6, more particularly, the beam 10 substantially comprises from the front to the rear, a plate 15 providing its closure in the front, front parts 16 for attaching frames 11, 12 to the beam 12, respectively at the upper and lower faces of this beam, a window 17 for letting through the steering column 45, a bearing 18, a plate 19 for mounting the steering column 45, rear parts 20 for attaching the frames 11, 12 to the beam 10, a roller 21, visible in FIG. 7, for guiding the chain 38 (simply schematized) belonging to the primary transmission 6, two stacks 22 for receiving a column for supporting the seat 5, and a bearing 23 for mounting the arm 13.

The plate 15 is visible in FIGS. 5 and 6. It comprises six holes for mounting it on the beam 10 and it forms a portion 25a of a spherical seat. The other portion 25b of this seat is fitted out with parts 26 forming a collar, engaged on the lower end of the steering column 45. The plate 15 and the parts 26 comprise holes for mounting the parts 26 on the plate 15, with confinement between them, of a spherical portion 51 fitted out on the steering column 45.

The bearing 18 is bolted on the upper wall of the beam 10 and receives a conventional type crankset 27, with one or more chainwheels, three chainwheels in the example illustrated as shown in FIG. 7. The upper wall of the beam 10 is bored with a series of holes allowing the bearing 18 to be mounted in several positions on the beam 10, and therefore the position of the crankset 27 may be adjusted according to the morphology of the user.

The plate 19 is also, in the illustrated example, bolted to the upper wall of the beam 10 (it may be fixed with any other means, for example, be welded). It receives a telescopic strut 28 pivotably mounted relatively to it. This strut 28 is formed with an outer tube and inner tube and is adjustable in length by means of a collar 29 which clamps the end of the outer component on the inner component. The strut 28 forms a bearing at its upper end into which the steering column 45 is engaged.

The stacks 22 are welded to the upper wall of the beam 10, and the bearing 23 is bolted (or may be welded) to the rear end of this beam by means of holes which it comprises, visible in FIGS. 8 and 9.

The frames 11, 12 are positioned relatively to the beam 10 so that their middle longitudinal axis coincides with the middle longitudinal axis of the beam, and are dimensioned so that the feet and the bottom of the legs of the user are located inside the perimeter which they delimit during pedaling. These frames 11, 12 form longitudinal sides parallel to the longitudinal axis of the vehicle and comprise, as shown in FIG. 4 particularly, pairs of mounting parts 30 forming clevises, for pivotably mounting suspension triangles 31 of each front wheel 2.

The upper frame 11 further comprises, between each pair of parts 30, a mounting part 32 forming a clevis, for pivotably mounting the end of a damper 33, the other end of this damper 33 being pivotably mounted at a clevis 34 integral with the protruding angle of the lower triangle 31, as shown in FIG. 4.

The upper frame 11 is further interrupted at right angles to the passage of the chain 38 which comprises the primary transmission 6, and receives a tubular part 35 delimiting a passage for the upper strand of this chain 38.

FIG. 4 shows in detail one of the front suspensions of the vehicle 1. Both triangles 31 comprise ball-and-socket joints 40 at their protruding angles, delimiting coaxial holes in which a wheel support 41 is pivotably mounted. Each wheel support 41 comprises a disc brake 42 and includes a rod 43 protruding towards the front of the vehicle 1, on the end of which an end of a steering rod 46 is jointed.

FIG. 5 shows the whole of the steering system, which comprises in addition to the steering column 45, the strut 28 and two steering rods 46 as aforementioned, U-shaped handlebars 47 fitted with brake controls 48 and a change speed gear 49 of known types.

The steering column 45 is formed with two telescopic tubes, which may be immobilized in a given position by means of a collar 50 which clamps the end of the outer tube on the inner tube.

As shown in FIG. 6 more particularly, the end of the outer tube forms the aforementioned spherical portion 51, and comprises a terminal square 52. The spherical portion 51 is intended to be confined, with the possibility of pivoting, between the surfaces 25a, 25b forming the seat of the plate 15 and parts 26, for guiding the pivoting of the steering column 45 while allowing the tilt of the latter to be adjusted by means of the strut 28. The square 52 as for it, is intended to be connected, by means of a screw (not shown) engaged into a washer 53, to a part 54 forming a lever, with blocking in rotation. This part 54 receives two pivots 55 integral with the ends of both steering rods 46, the other ends of these rods 46 being jointed on the end of the rods 43, as described earlier.

FIGS. 7-9 show that the primary transmission 6 comprises, in addition to the crankset 27, the chain 38 and the roller 21, a series of pinions 56 with different diameters and a derailleur 57 of a conventional type, borne by a supporting part 58. This supporting part 58 is attached on the upper face of the bearing 23. The pinions 56 are fixed on the end of the shaft providing the mounting of the pivoting arm 13 on the bearing 23, this shaft comprising on its other end a pinion 60 fixed on it, belonging to the secondary transmission 7, visible in FIG. 9.

The arm 13 is formed with a box beam 61, receiving two parts 62, 63 at its ends.

As shown in FIG. 9, the part 62 intended to be assembled to the bearing 23, forms a clevis for its mounting on this bearing 23, whereas the part 63, as shown in FIG. 10, forms a bore 64. This bore 64 may receive either a long shaft 65 bearing two rear wheels 2, or a short shaft 66 bearing a single rear wheel.

On its upper face, the arm 13 receives a bolted mounting part 70, forming a clevis, on which the end of a damper 71 is pivotably mounted. The other end of the damper 71 is pivotably mounted in a clevis which forms a mounting part 72 fixed on a tilted square base which the bearing 23 forms. The upper wall of the beam 61 is bored with a series of holes with which the part 70 may be mounted in several positions on the beam 61, and the tilt of the damper 71 and consequently the stiffness of the rear suspension which are formed by parts 70 and 72 and the damper 71, as well as the height of the rear of the vehicle may be adjusted.

The shaft 65 or 66 comprises, fixed on it, a pinion 75 belonging to the secondary transmission 7, this pinion 75 and the pinion 60 meshing with a chain 76 (simply schematized). The shaft 65 or 66 also receives a brake disc 80, the caliper 81 of the brake being mounted onto the part 63.

As visible in FIG. 7, the seat is mounted on a plate 85 itself borne by a tube 86 capable of being slidably engaged into either one of the stacks 22 and of being immobilized, relatively to this stack 22 by means of a clamping collar 87. This tube 86 is itself slidably connected to the plate 85, along the front-rear direction of the latter, and with possibility of being blocked in a determined position.

These arrangements form means with which the height of the seat 5 may be adjusted according to the position of the tube 86 in the stack 22 into which this tube is engaged, as well as the longitudinal position of this seat 5, according to the stack 22 used, and to the relative position of the tube 86 and of the plate 85.

FIG. 11 shows an alternative embodiment of the vehicle 1. The already described components which are again found in this alternative are designated by the same numerical references and are not described again.

In this case, the vehicle 1 comprises a single frame 110 as a replacement for frames 11 and 12 described above, and each side of this frame 110 forms two stacked horizontal side members 111, 112 which allow, in the same way as described earlier, the mounting of the triangles 31 and of the damper 33.

As this is apparent from the foregoing, the invention provides a pedal-powered vehicle with three or four wheels, having many advantages as compared with homologous vehicles of the prior art. In particular, this vehicle has an average wheel base, provides good protection to the legs of the user, and has good performances of handleability and stability in curves. This vehicle further has performing suspensions, provides a comfortable driving position and has a chassis structure 3 with a good weight/stiffness ratio, relatively simple to make, and allowing the different members of the vehicle to be mounted easily.

It is obvious that the invention is not limited to the embodiment described above by way of example, but that it extends to all embodiments covered by the claims appended herewith.

1. Three- or four-wheeled pedal-powered vehicle, characterized in that its chassis (3) comprises a central beam (10) and at least one horizontal frame (11, 12), fixed to the front side of the beam (10); the beam (10) includes different members of the vehicle, in particular the steering column (45) and a crankset support (18) located level with the axle of both front wheels (2), or slightly in front of or behind this axle, and mounted in such a way that each pedal is located on one side of the beam (10), said beam (10) being further connected to the rear wheel(s) (2); the frame(s) (11, 12) are dimensioned such that the user's feet and part of his/her legs are located inside these frame(s) during pedaling, the frame(s) forming, on each side, two stacked horizontal side members, onto which one of the front wheel(s) (2) of the vehicle is mounted.

2. Vehicle according to claim 1, characterized in that it comprises a seat (5) mounted on the beam (10), conformed in order to receive the user in a substantially sitting position, slightly tilted rearwards.

3. Vehicle according to claim 1, characterized in that each side of a frame (11, 12) comprises a suspension triangle (31) pivotably mounted relatively to it around a longitudinal axis, both triangles (31) located on a same side being connected to a part (41) including the wheel (2), and a damper (33) being placed between this part (41) and one of the side members of the frame(s) (11, 12).

4. Vehicle according to claim 1, characterized in that the rear wheels (2) are mounted on an arm (13) pivotably connected at the rear end of the beam (10) so that this arm (13) may swing in a vertical plane, a damper (71) being placed between this swinging arm and the beam (10).

5. Vehicle according to claim 4, characterized in that the vehicle comprises a primary transmission (6) formed by a chain (38) extending between at least one chainwheel of the crankset (27), and at least one pinion (56) coaxial with the pivot axis of the swinging arm (13), and a secondary transmission (7) formed by a chain (76) extending between at least one pinion (60) rotationally integral with the pinion(s) (56) of the primary transmission (6), and at least one pinion (75) rotationally integral with the rear wheel(s).

6. Vehicle according to claim 1, characterized in that the beam (10) or the swinging rear arm (13), comprises a transverse bore (64) which may receive either a short shaft (66) supporting a single rear wheel (2), or a long shaft (65) which may receive two wheels (2).

7. Vehicle according to claim 1, characterized in that it comprises a tilted steering column (45).

8. Vehicle according to claim 7, characterized in that it comprises means (28, 29, 50) for adjusting the length and/or the tilt of this steering column (45).

9. Vehicle according to claim 1, characterized in that the beam (10) (10) includes a series of holes making it possible to adjust the position of the crankset (27) (27) according to the morphology of the user.

10. Vehicle according to claim 4, characterized in that the arm (13) includes a series of holes making it possible to adjust the tilt of the damper (71) and consequently the stiffness of the rear suspension formed by this damper, as well as the height of the rear part of the vehicle.

11. Vehicle according to claim 1, characterized in that it includes means (85 to 87) making it possible to adjust the height of the seat (5) as well as the longitudinal position of this seat (5).

12. Vehicle according to claim 2, characterized in that each side of a frame (11, 12) comprises a suspension triangle (31) pivotably mounted relatively to it around a longitudinal axis, both triangles (31) located on a same side being connected to a part (41) including the wheel (2), and a damper (33) being placed between this part (41) and one of the side members of the frame(s) (11, 12).
